(19) United States
(12) Patent Application Publication
(10) Pub. No.: US 2008/0126497 A1
(43) Pub. Date: May 29, 2008

(54) Controller Apparatus with Shared Expansion Connection and Method for the same

(76) Inventors: Shih-Chieh Laio, Taoyuan Hsien (TW); Tai-Tsung Huang, Taoyuan Hsien (TW)

Correspondence Address: HDSL, 4331 STEVENS BATTLE LANE, FAIRFAX, VA, 22033, US

(21) Appl. No.: 11/463,687

(22) Filed: Aug. 10, 2006

(51) Int. Cl. G06F 15/16; H04L 12/40

(52) U.S. Cl. 709/208; 709/253

(57) ABSTRACT

A controller apparatus with shared expansion connection and method for the same includes a plurality of controller and each controller with a built-in programmable logic controller (PLC). The controllers communicate through signal interfaces and detect unused transmission interfaces in the programmable logic controllers. The unused transmission interface can be used by other controllers by share setting and functional setting. The transmission function is improved and the transmission interfaces do not need augmentation.

### BACKGROUND OF THE INVENTION

1. Field of the Invention

The present invention relates to a controller apparatus, especially to a controller apparatus with built-in PLC for each controller and communicated through a plurality of signal interfaces between controllers, the controllers of the controller apparatus can utilize unused transmission interface of PLC of other controllers for expanding the transmission interface thereof

2. Description of Prior Art

Controller apparatus such as inverter, server, human-machine interface (HMI), and temperature module are extensively used in electronic or electrical products requiting controlled operation. The connection and operation of the controller apparatus are generally controlled through programmable logic controller (PLC). The PLC directly controls internal memory for outputting signal to provide no-delay and noise-free operation. The PLC comprises a plurality of external pins for function setting to provide expansion function by external program. However, the expansion ability of the controller apparatus is limited by the preset amount of transmission interfaces and expansion module (expansion card) is needed when the function of the controller apparatus is to be expanded.

FIG. 1 shows a prior art inverter with built-in PLC. The transmission interfaces of the inverter comprise analog input/output 11, 12, Digital In/Out 13, 14 and communication interface 15, which are all fixed interfaces. When the interface of the inverter 1 is to be expanded, user needs to buy analog input/output card, Digital In/Out card and communication interface card, and the expansion ability is limited. When user utilizes two or more sets of inverters, parts of the transmission interfaces of the PLC built in the inverter (which is outside the main console) are not used.

### SUMMARY OF THE INVENTION

The present invention is to provide a controller apparatus with built-in PLC for each controller and communicated through a plurality of signal interfaces between controllers, the controller apparatus can use unused transmission interface of PLC of other controller for expanding the transmission interface thereof by sharing setting and interface function setting, whereby the cost for expansion card can be saved.

Accordingly, the present invention provides a controller apparatus with shared expansion connection, comprising:

a plurality of controllers;

a programmable logic controllers (PLC) built in each controller, comprising a plurality of transmission interfaces;

a plurality of signal interfaces connected among the plurality of controller apparatus;

wherein the controller apparatus can identify unused transmission interface of the PLC of other controller apparatus through thesignal interfaces and the unused transmission interface of the PLC can be shared to other controller apparatus by share setting and interface function setting.

Moreover, the present invention provides a method for providing shared expansion connection to controller apparatus, comprising:

providing a plurality of controller apparatus, each of the controller apparatus comprising transmission interfaces;

providing plurality of signal interfaces connected among the plurality of controller apparatus;

detecting unused transmission interface of the PLC through the signal interfaces; and

sharing the g unused transmission interface of the PLC to other controller apparatus by share setting and interface function setting.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a prior art inverter with built-in PLC.

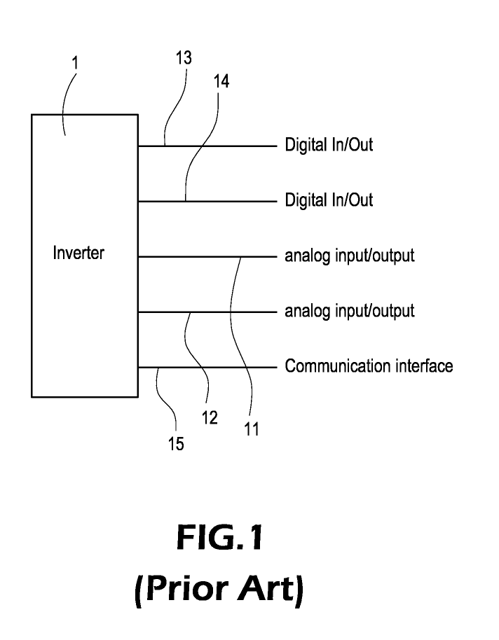

FIG. 2 shows the block diagram of the controller apparatus with shared expansion connection according to the present invention.

FIG. 3 shows the block diagram of inverters using the shared connection according to the present invention.

FIG. 4 shows the flowchart for the operation of the controller apparatus with shared expansion connection according to the present invention.

FIG. 5 shows the flowchart of setting the sharing of transmission interfaces for the controller apparatus.

FIG. 6 shows that communication time is divided into four parts when there are four master controller apparatus.

### DETAILED DESCRIPTION OF THE INVENTION

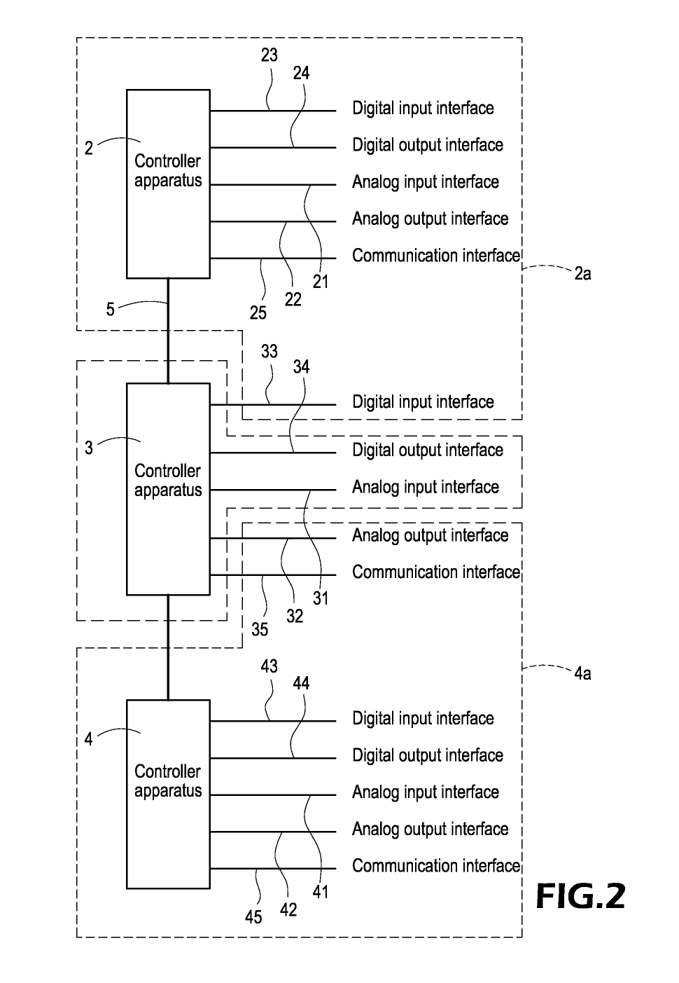

FIG. 2 shows the block diagram of the controller apparatus with shared expansion connection according to the present invention. The controller apparatus with shared expansion connection comprises a plurality of controller apparatus 2, 3, and 4 electrically connected to each other. Each of the controller apparatus 2, 3, and 4 comprises a built-in PLC (not shown). The PLC is connected to external control end through analog input interfaces 21, 31, 41, analog output interfaces 22, 32, 42, digital input interfaces 23, 33, 43 and digital output interfaces 24, 34, 44, and communication interfaces 25, 35 and 45. When the transmission interface of one controller apparatus 2, 3 or 4 is not used, the unused transmission interface can be used by other controller apparatus to achieve shared use of transmission interfaces and save the cost for expansion cards.

The controller apparatus 2, 3 and 4 can be any controller with built-in PLC such as one of inverter, server, HMI or temperature controller. Thesignal interface 5 among the controller apparatus 2, 3 and 4 can be realized by CANBUS, RS485 or network connection to provide communication among the controller apparatus 2, 3 and 4. Therefore, the controller apparatus 2, 3 and 4 can identify unused transmission interface by communication through thesignal interface 5; and the unused transmission interface of one controller apparatus can be shared to other controller apparatus, or other system to reduce cost.

With reference again to FIG. 2, when there are three controller apparatus 2, 3 and 4, the controller apparatus 2 and 4 can be set as master and referred to as first system 2a and second system 4a, respectively. The transmission interfaces of the controller apparatus 3 can be divided into three portions. In first portion, the unused digital input interface 33 of the PLC of the controller apparatus 3 is set to be shared to the controller apparatus 2 and to form as expanded transmission interface of the controller apparatus 2. The second portion contains the analog input interface 31 and the digital output interface 34. In the third portion, the unused analog output interface 32 and the communication interface 35 of the PLC of the controller apparatus 3 are set to be shared to the controller apparatus 2 and to form as expanded transmission interfaces of the controller apparatus 2.

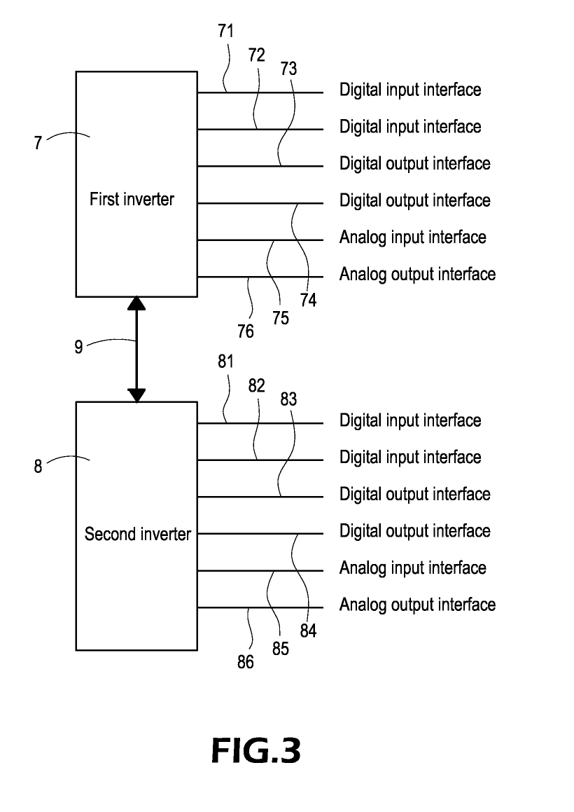

FIG. 3 shows the block diagram of inverters using the shared connection according to the present invention. As shown in this figure, the first inverter 7 is electrically connected to the second inverter 8 through signal interface 9, where the first inverter 7 and the second inverter 8 comprises two digital input interfaces (DI0-DI1) 71, 72, 81, 82, two digital output interfaces (DO0-DOI) 73, 74, 83, 84, an analog input interface (AI0) 75, 85 and an analog output interface (AO0) 76, 86.

A built-in program can know that the PLC in the first inverter 7 already uses a digital input interface (DI0) 71, two digital output interfaces (DO0, DO1) 73, 74 and an analog input interface (AI0) 75 through thesignal interface 9. In other word, the PLC of the first inverter comprises unused digital input interface (DI0) 72 and analog input interface (AI0) 76, which can be used as expanded interface of other inverters by programming or function setting. Moreover, the ID parameter of the second inverter 8 can be set such that the unused digital input interface (DI0) 72 and analog input interface (AI0) 76 of the first inverter 7 can be set as expanded transmission interface of the second inverter 8. In other word, the second inverter 8 can directly control unused digital input interface (DI0) 72 and analog input interface (AI0) 76 of the first inverter 7 by the PLC thereof or parameter control.

In the present invention, a plurality of controller apparatus are connected through signal interfaces and the unused transmission interface of the PLC can be identified by built-in program of the controller apparatus. The unused transmission interfaces can be shared to other controller apparatus by program or interface function setting. Therefore, the expansion ability is enhanced and the expense for purchasing new expansion card is saved.

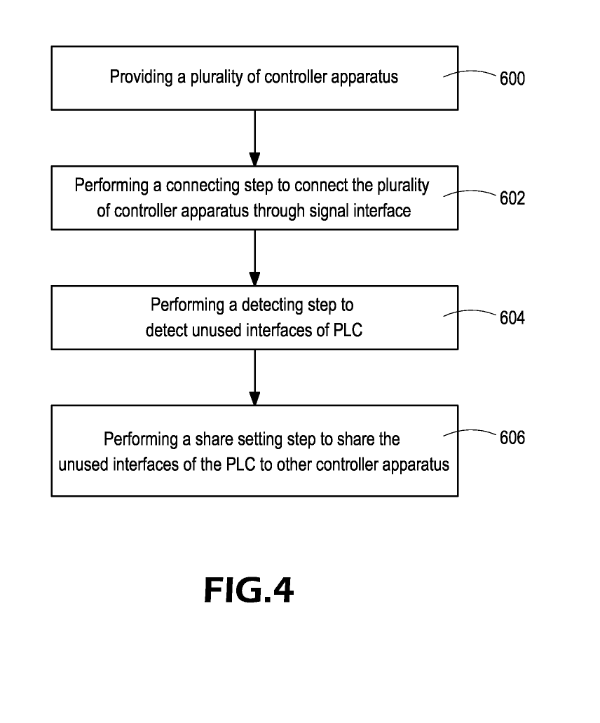

FIG. 4 shows the flowchart for the operation of the controller apparatus with shared expansion connection according to the present invention.

Step 600: Providing a plurality of controller apparatus, wherein each of the controller apparatus comprises a built-in PLC with a plurality of transmission interfaces.

Step 602: Performing a connecting step to connect the plurality of controller apparatus through signal interfaces such as CANBUS, RS485 or network.

Step 604: Performing a detecting step to detect unused transmission interfaces of PLC by built-in program through the signal interfaces.

Step 606: Performing a share setting step to share the unused transmission interfaces of the PLC to other controller apparatus, where the share setting and interface function setting are set by program.

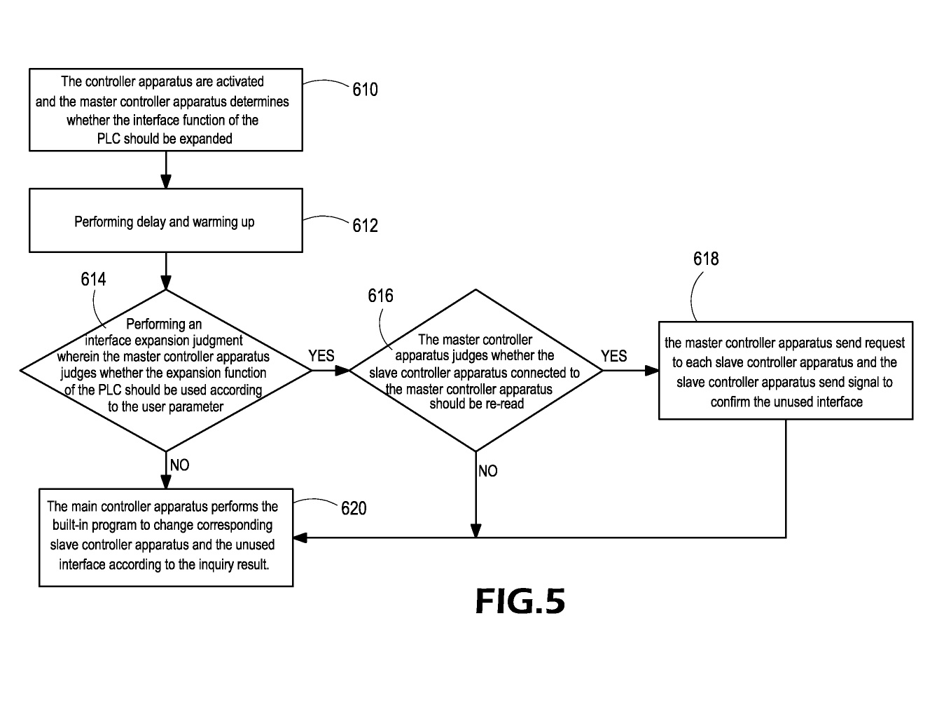

FIG. 5 shows the flowchart of setting the sharing of transmission interfaces for the controller apparatus. In detecting and interface sharing steps, the unused transmission interface of PLC is detected and shared.

In step 610, the controller apparatus are activated. The controller apparatus include at least one master controller apparatus such as the controller apparatus 2 and 4 in FIG. 2, and at least one slave controller apparatus such as controller apparatus 3 in FIG. 2, which is set to share transmission interface. The master controller apparatus has the ability to determine whether the interface function of the PLC should be expanded.

Step 612 performs delay and warming up. When the expansion function of the PLC is to be used after the controller apparatus are activated, the master controller apparatus will be delayed a specific period for warming up, the warming up procedure can be defined by user parameter.

Step 614 performs an interface expansion judgment wherein the master controller apparatus judges whether the expansion function of the PLC should be used according to the user parameter.

Step 616 performs an interface inquiry step, wherein the master controller apparatus judges whether the slave controller apparatus connected to the master controller apparatus should be re-read according to the user parameter. When the user parameter is true, the master controller apparatus will send request to each slave controller apparatus to identify unused transmission interface, and the slave controller apparatus automatically detects the unused transmission interface thereof and sends signal to confirm the unused transmission interface in step 618. The master controller apparatus will send request to each slave controller apparatus to identify unused transmission interface and will wait for a specific time period when the slave controller apparatus replies with no unused transmission interface. The specific time period is defined by user parameter and will last until the master controller apparatus inquires all slave controller apparatus.

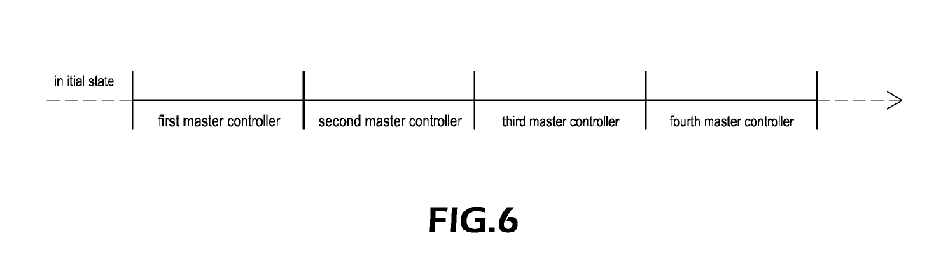

When there are multiple master controller apparatus, the master controller apparatus will send request to the slave controller apparatus connected thereto in the interface inquiry step. To prevent erroneous signals when the signals are simultaneously sent, the communication time of the inquiry signals are subject to time division. The communication time is divided into four parts when there are four master controller apparatus as shown in FIG. 6. The first time segment is used by the first master controller apparatus, the second segment is used by the second master controller apparatus, and so on, in cyclic manner. Therefore, the master controller apparatus can request the slave controller apparatus with unused transmission interface and the slave controller apparatus can automatically detect the unused transmission interface thereof and sends signal to identify the unused transmission interface.

Step 620 performs the interface sharing. The main controller apparatus performs the built-in program to change corresponding slave controller apparatus and the unused transmission interface according to the inquiry result.

The setting for the slave controller apparatus can be set by parameter of PLC. For example, the syntax for the digital input interface and digital output interface can be 0×AABB, where AA is corresponding to station number of slave controller apparatus, BB is the shared digital input interface and digital output interface. Moreover, the digital input interface and digital output interface can be corresponding to two registers in the PLC. One is corresponding to name of slave controller apparatus and another is corresponding to value, which has range 0˜FFFF for 16 bits.

The interface expansion method of the present invention can efficiently use the transmission interface of the PLC. Moreover, user can set up unused transmission interface of one controller apparatus to other controller apparatus. The expansion ability is enhanced and the cost is reduced.

Although the present invention has been described with reference to the preferred embodiment thereof, it will be understood that the invention is not limited to the details thereof Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A controller apparatus with shared expansion connection, comprising:
a plurality of controllers;
a programmable logic controller (PLC) built in each controller, comprising a plurality of transmission interfaces;
a plurality of signal interfaces connected among the plurality of the controller;
wherein one controller is identified with unused transmission interfaces of the PLC through the signal interfaces and the unused transmission interfaces can be shared to other controllers by share setting and interface function setting.

2. The controller apparatus as in claim 1, wherein the controller is an inverter.

3. The controller apparatus as in claim 1, wherein the controller is a server.

4. The controller apparatus as in claim 1, wherein the controller is a human machine interface (HMI).

5. The controller apparatus as in claim 1, wherein the controller is a temperature control module.

6. The controller apparatus as in claim 1, wherein the signal interface is CANBUS.

7. The controller apparatus as in claim 1, wherein the signal interface is RS485.

8. The controller apparatus as in claim 1, wherein the signal interface is Internet.

9. A method for providing shared expansion connection to a controller apparatus, comprising:
providing a plurality of controllers, each comprising a built-in programmable logic controller (PLC) with a plurality of transmission interfaces;
providing a plurality of signal interfaces connected among the plurality of controllers;
detecting unused transmission interfaces of the PLC of one controller through the internal communication interfaces; and
sharing the unused transmission interfaces to other controllers by share setting and interface function setting.

10. The method as in claim 9, wherein the plurality of controllers comprise at least one master controller and at least one slave controller.

11. The method as in claim 9, wherein the step of detecting unused transmission interfaces of the PLC further comprising:
activating the master controller and the slave controller;
the master controller judging whether an expansion function of the PLC should be used by parameters;
the master controller judging whether the slave controller should be re-read through the signal interface by the parameters;
the master controller sending inquiry signals to the slave controller when the slave controller should be re-read, the slave controller sending signals for indicating the unused transmission interfaces thereof, and
the master controller executing an internal program to change the slave controller and the unused transmission interfaces according to the inquiry.

12. The method as in claim 11, further comprising
the master controller delaying a predetermined time period for warming up when the expansion function of the PLC should be used by the parameters.

13. The method as in claim 12, wherein the warming up is defined by a user from the parameters.

14. The method as in claim 12, wherein the master controller delays a predetermined waiting time to request the slave controller when the slave controller replies with no unused transmission interface.

15. The method as in claim 14, wherein the predetermined waiting time is defined by a user from the parameters.

16. The method as in claim 9, further comprising
dividing a communication time of the master controller into a plurality of time segments;
the master controller sending the inquiry signals to the slave controller during one time segment; and
the slave controller automatically sending the signal for indicating the unused transmission interfaces thereof after receiving the inquiry signal.

17. The method as in claim 9, wherein the signal interface is CANBUS.

18. The method as in claim 9, wherein the signal interface is RS485.

19. The method as in claim 9, wherein the signal interface is Internet.

20. The method as in claim 9, wherein the controller is an inverter.

21. The method as in claim 9, wherein the controller is a server.

22. The method as in claim 9, wherein the controller is a human machine interface (HMI).

23. The method as in claim 9, wherein the controller is a temperature control module.
